(19) United States
(12) Patent Application Publication
(10) Pub. No.: US 2011/0006526 A1
(43) Pub. Date: Jan. 13, 2011

(54) Pitch control arrangement for wind turbine

(75) Inventor: Jonas Hemmingsson, Stockholm (SE)

Correspondence Address: YOUNG & THOMPSON, 209 Madison Street, Suite 500, Alexandria, VA, 22314, US

(73) Assignee: LILJEHOLM KONSULT AB, Stockholm (SE)

(21) Appl. No.: 12/809,712

(22) PCT Filed: Dec. 19, 2008
(86) PCT No.: PCT/SE2008/051541

§ 371 Date: Jul. 29, 2010

(30) Foreign Application Priority Data
Dec. 20, 2007 (SE) 0702854-1

(51) Int. Cl. H02P 9/04

(52) U.S. Cl. 290/44

(57) ABSTRACT

A pitch control arrangement for a wind turbine of the vertical axis type. Cam element and cam follower element are arranged to set the pitch angle of a turbine blade in accordance with a predetermined cyclic variation. The cam element includes a cam surface of different cam profiles, which define different predetermined cyclic variation of the pitch angle. The present invention provides an improved efficiency for a wind turbine irrespective of actual wind conditions, and further, both self-starting capability and high efficiency at a wide range of rotation speeds is accomplished using a simple and reliable construction.

### TECHNICAL FIELD OF THE INVENTION

The present invention relates to wind turbines and in particular to an arrangement for control of the pitch angle of the turbine blades in wind turbines of the vertical axis type.

### BACKGROUND OF THE INVENTION

Wind turbines are used to convert the kinetic energy of the wind to power by use of turbine blades rotatably arranged on a drive shaft. The wind exerts a force on the turbine blades, which by rotation of the turbine blades is transformed to a torque about the longitudinal axis of the drive shaft driving the drive shaft. The rotating drive shaft is connected to a generator to produce electrical power, or any other form of power medium. If the torque of the drive shaft is directly used for driving of a pump or the like the wind turbine is commonly known as a wind mill.

Numerous designs of wind turbines have been presented. Generally, these designs fall in two categories, i.e. horizontal axis wind turbines and vertical axis wind turbines. Most common are horizontal axis wind turbines, wherein the turbine blades are arranged in a propeller-like manner about the longitudinal axis of the horizontal drive shaft forming a rotor, which is placed at the top of a tower. The rotor has to be pointed in the direction of the wind. Usually the generator and/or a gearbox, which converts the rotation speed of the blades to a rotation speed more convenient for power generation, are placed at the top of the tower. Vertical axis wind turbines have turbine blades arranged in a carousel manner about the longitudinal axis of the drive shaft, which is directed perpendicular to the direction of the wind. Usually the drive shaft is vertical, although the drive shaft also can be placed horizontally. The general advantages of a vertical axis wind turbine versus a horizontal axis wind turbine are that:
the generator and other heavy parts for power generation or parts requiring maintenance can be placed in the ground level;
the strength of the tower can be used to catch more wind;
the turbine blades are subjected to equal speed of wind over the length of the blades, which makes it possible to have uniform cross-sectional shape along the length of the blade;
the turbine blades are generally moving at a lower speed, which makes it possible to make more silent wind turbines; and
the theoretical maximal efficiency is higher.

The motive force of the wind turbines comprises a drag force and/or a lift force acting on the turbine blades. The drag force originates from wind impinging on the surface of the turbine blade and transferring momentum as the wind is slowed down. The lift force is generated perpendicular to the motion of an airfoil shaped body, i.e. the turbine blade, moving through an air flow. The relative magnitude of the lift force and the drag force is dependent on the airfoil shape. Further the direction and magnitude of the resultant force can be controlled by varying the pitch angle of the turbine blade.

Vertical axis wind turbines are usually either of two principal types, i.e. drag-type turbines or lift-type turbines. The drag-type turbines are driven by the drag forces. One advantage with the drag-type is that it is self-starting. However, the drag-type wind turbine has a limited rotational speed, and hence a limited efficiency, since the rotational speed cannot exceed the wind speed. The lift-type wind turbines use the lift force component in the tangential direction for driving, whereby the rotational speed, and hence the efficiency, is higher. Commonly, lift-type turbines will not self-start.

A vertical axis wind turbine having turbine blades fixedly mounted to the drive shaft allows for a simple construction, although with a limited power generating sector and an extensive retarding sector, which limits the efficiency. Consequently, the vertical axis wind turbines are commonly provided with pivotally mounted turbine blades. Thereby the pitch angle of the turbine blade can be cyclically varied to increase the extension of the power generating sector and to increase the resultant driving force of the turbine blade.

Vertical axis wind turbines according to prior art commonly accomplishes a cyclic variation of the pitch angle of the turbine blade for improvement of the efficiency by having a linkage connecting the turbine blade to an eccentric point, which is radially displaced from the longitudinal axis of the drive shaft. Moreover, the radial displacement of the eccentric point can be adjusted to accomplish different cyclic variation depending on the wind direction. Such a cyclic variation substantially improves the efficiency, at least at certain air flow conditions. However, the pitch angle will not be ideal in all angular positions of the turbine blade about the drive shaft.

### SUMMARY OF THE INVENTION

One object of the present invention is to provide a wind turbine of the vertical axis type which allows an optimised pitch angle control irrespective of wind direction, wind speed and rotation speed of the turbine blades.

The object of the present invention is achieved by the pitch control arrangement, the wind turbine and the method of controlling such as defined in the independent claims.

According to one aspect the present invention provides a pitch control arrangement for a wind turbine of the vertical axis type that comprises a turbine blade arranged for rotation about a longitudinal rotation axis of the wind turbine. Cam means and cam follower means are arranged to set the pitch angle of the turbine blade in accordance with a predetermined cyclic variation as the turbine blade rotates about the longitudinal rotation axis. Preferably the turbine blade is pivoted about a longitudinal pitch axis of the turbine blade.

The cam means comprises a cam surface of different cam profiles in the direction of the longitudinal rotation axis, which define different predetermined cyclic variation of the pitch angle. The relative position of interaction between the cam means and the cam follower means in the direction of the longitudinal rotation axis is variable.

In one embodiment of the present invention the cam means provides intermediate cam profiles that define additional predetermined cyclic variations of the pitch angle.

In one embodiment the cam means comprises continuous transition regions between cam profiles and the predetermined cyclic variation can be varied by arranging the cam follower means on continuous transition regions between different cam profiles.

In another embodiment the cam means is split into a first half and a second half, whereby the predetermined cyclic variation can be varied by moving the first and the second half relative each other.

According to another aspect the present invention provides a wind turbine of the vertical axis type comprising said pitch control arrangement.

According to yet another aspect the present invention provides a method for controlling a pitch angle of a turbine blade in a wind turbine of the vertical axis type by using said pitch control arrangement. The method comprises the step of altering the relative position of interaction between the cam means and the cam follower means along the longitudinal rotation axis of the pitch control arrangement. Preferably the method further comprise the steps of pivoting the cam means to adjust for a change in wind direction and moving two halves of the cam means relative each other to obtain a downwind compensation.

Thanks to the invention it is possible to provide a pitch control arrangement accomplishing a high efficiency wind turbine of the vertical axis type.

It is a further advantage of the invention to provide a pitch control arrangement allowing a simple and reliable construction of a high efficiency wind turbine of the vertical axis type.

It is yet a further advantage of the invention to provide a pitch control arrangement which provides self-starting as well as optimal efficiency at a wide range of rotational speeds.

Embodiments of the invention are defined in the dependent claims. Other objects, advantages and novel features of the invention will become apparent from the following detailed description of the invention when considered in conjunction with the accompanying drawings and claims.

### BRIEF DESCRIPTION OF THE DRAWINGS

Preferred embodiments of the invention will now be described with reference to the accompanying drawings, wherein

FIG. 1 is a schematic illustration of a vertical axis wind turbine,

FIG. 2 is a schematic cross sectional view of a turbine blade showing the aerodynamic forces generated on the turbine blade upon rotation about the longitudinal rotation axis,

FIG. 3 is a schematic illustration of pitch angle control of a turbine blade using a linkage that is connected to an eccentric point, which is radially displaced from the rotation axis,

FIG. 4 is a schematic illustration of pitch angle control of a turbine blade according to FIG. 3, wherein the eccentric point coincides with the rotation axis,

FIG. 5 is a schematic illustration of a pitch angle control arrangement comprising an asymmetric cam means for low rotation speed according to the present invention,

FIG. 6 is a schematic illustration of a pitch angle control arrangement comprising a symmetric or near-symmetric cam means for high rotation speed according to the present invention,

FIG. 7 is a cross sectional view of a cam means split into two halves according to the present invention,

FIG. 8 is a schematic illustration of a pitch angle control arrangement for a) relatively low wind speed and low rotation speed; b) according to a), but with different wind direction and hence having the cam means rotated; and c) relatively high wind speed and high rotation speed, according to the present invention,

FIG. 9 is a schematic illustration of a vertical axis wind turbine comprising a pitch angle control arrangement and four turbine blades, wherein push rods follow the cam surface to control the pitch angle of the turbine blades according to the invention,

FIG. 10 is a schematic illustration of a cam means according to the present invention,

FIG. 11 is a schematic block diagram of a pitch control system according to the present invention, and

FIG. 12 is a schematic diagram of a method according to the present invention.

### DETAILED DESCRIPTION OF EMBODIMENTS

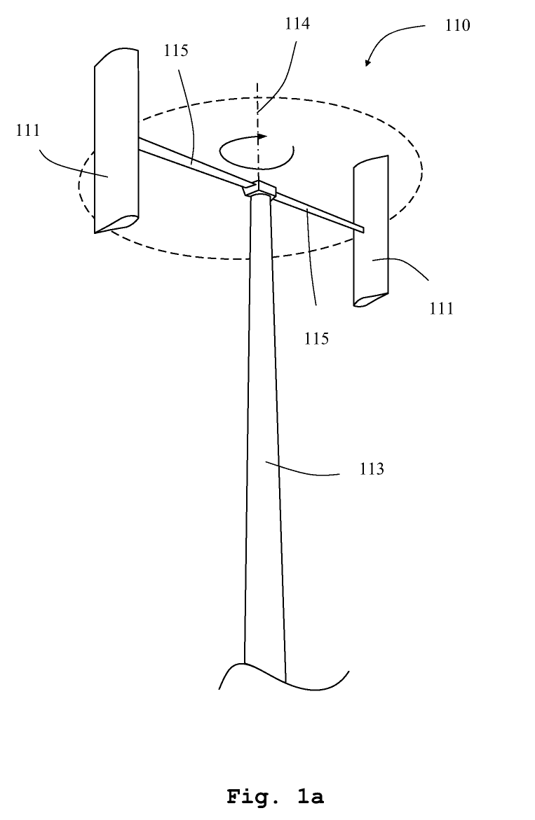

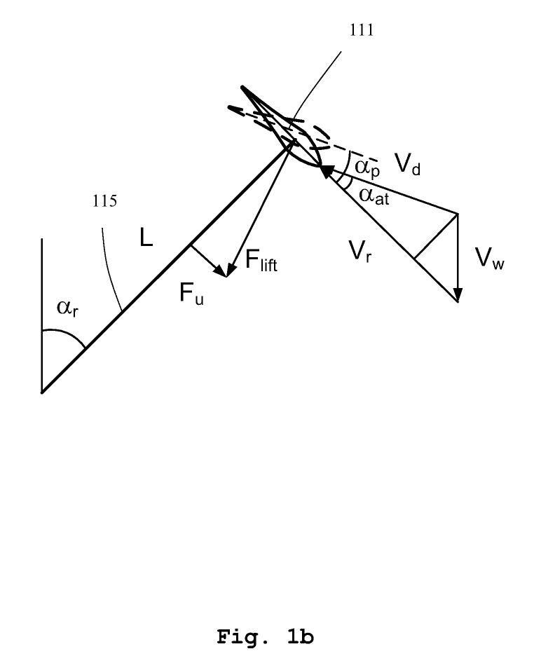

FIG. 1a schematically illustrates a common design for a vertical axis wind turbine 110 according to prior art. This particular vertical axis wind turbine 110 comprises two turbine blades 111 having a cross sectional shape of an airfoil arranged in a carousel manner about a longitudinal rotation axis 114 of a vertical drive shaft 113 by horizontal support arms 115. The vertical drive shaft 113 is generally rotatably mounted on a support structure comprising a generator and/or a gear box at the ground level. Commonly the drive shaft 113 extends within a tower. In a basic design the turbine blades 111 are fixed to the support arms 115.

FIG. 1b schematically illustrates a vector diagram of wind currents and forces acting on the turbine blade 111 at a certain angular position, αᵣ, relative the current wind, V_{w}. The turbine blade 111 is arranged on a support arm 115 having a length, L, which is mounted on the drive shaft 113. The turbine blade 111, which in FIG. 1b is oriented in the tangential direction, has the shape of an airfoil with a rounded leading edge, followed by a sharp trailing edge. Upon rotation of the turbine blade 111 about the longitudinal axis of the drive shaft 113, there will be an additional wind current, Vᵣ, oriented in the opposite direction of the motion direction of the turbine blade 111 due to the rotation. The wind component, V_{d}, at an angle αₐₜ experienced by the turbine blade 111 is determined by V_{w} and Vᵣ and varies as αᵣ changes. Accordingly a lift force, F_{lift}, acts on the turbine blade 111. The useful radial force component, Fᵤ, of F_{lift} determines the driving force. The relationship between the current wind V_{w}, and the wind current, Vᵣ, will vary. Consequently the pitch angle, αₚ, of the turbine blade 111 can be controlled to improve the driving force.

A complicating factor is that the wind speed decreases in the downstream sector of the turbine blade 11, since energy has been extracted form the wind current during the motion through the upwind sector, which reduces the wind current through the turbine. Hence the downstream side of the revolution experiences a lower wind speed than the upstream side. This phenomenon is in the following called downstream reduction.

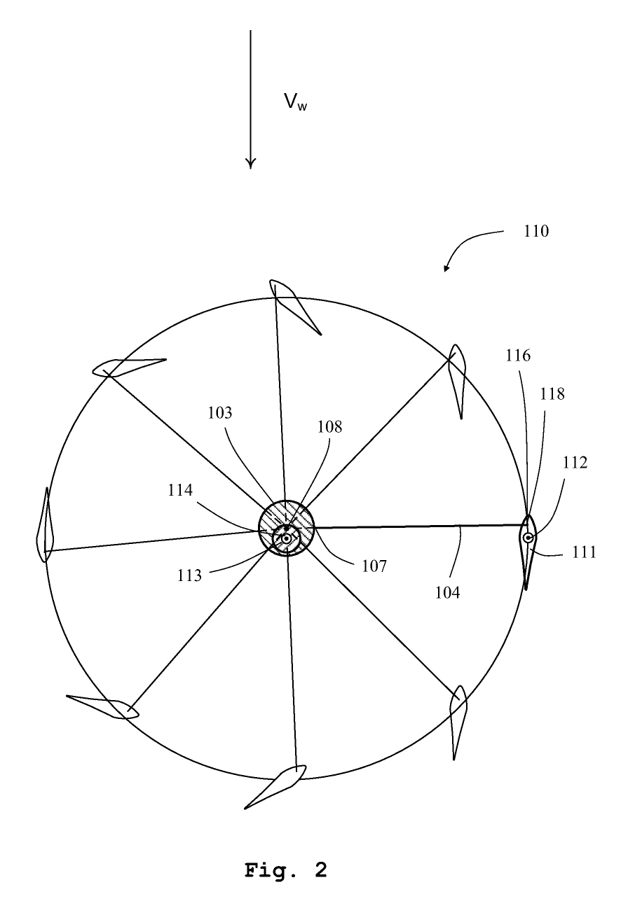

Referring to FIG. 2, in an alternative design of the vertical axis wind turbine 110 according to prior art, the turbine blades 111 are pivotally mounted on the support arms 115 (not shown) allowing variation of the pitch angle about a longitudinal pitch axis 112 of the turbine blades 111, which is substantially parallel with the longitudinal rotation axis 114 of the drive shaft 113. Rods 104 are in one end pivotally mounted at a pivot point 118 on the turbine blades 111 positioned between the leading edge 116 of the turbine blades 111 and the longitudinal pitch axis 112 and in the other end mounted on a peripheral point 107 on a circular profile 103 arranged about the drive shaft 113 in such way that the rods 104 are pointing radially out from the centre 108 of the circular profile 103. The centre of the circular profile 103, i.e. corresponding to the eccentric point 108 above, is radially displaced from the longitudinal rotation axis 114 of the drive shaft 113. Thereby the rods 104 determine the pitch angle αₚ of the turbine blades 111 upon rotation according to the relative position of the peripheral point 107 on the circular profile 103 compared to the longitudinal rotation axis 114 of the drive shaft 113, which improves the efficiency of the wind turbine 110. The radial displacement and the angular position of the eccentric point 108 may be altered to obtain a different cyclic variation depending on the magnitude and direction of the wind.

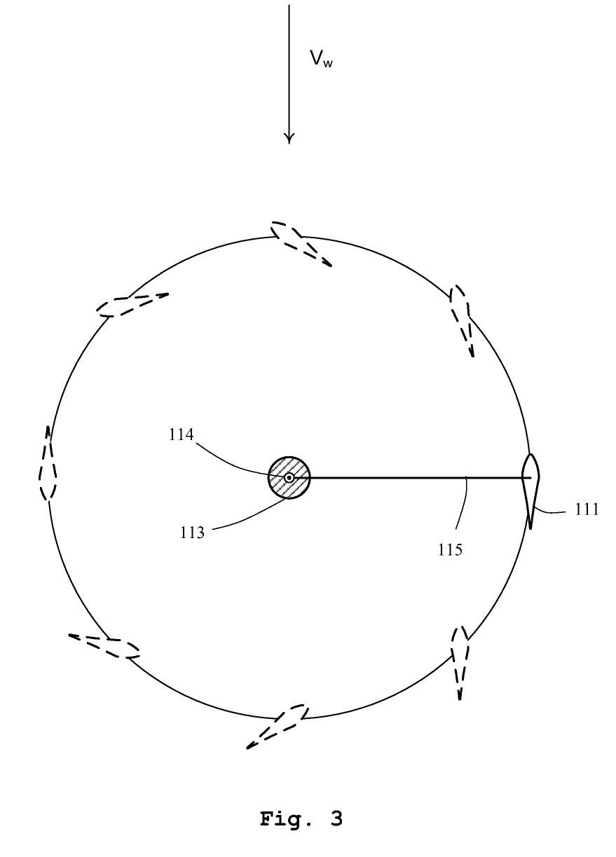

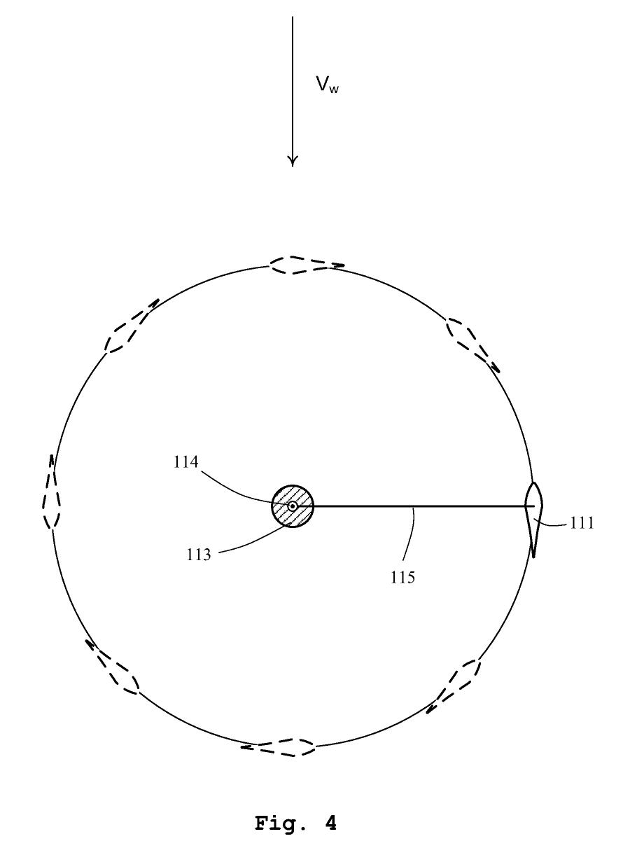

In an ideal vertical axis wind turbine 110 each turbine blade 111 contributes with maximal tangential force in any angular position αᵣ of the turbine blade 111 about the longitudinal axis 114 of the drive shaft 113, except for the positions wherein the turbine blade 111 moves perfectly downstream or upstream of the wind. This maximal tangential force is obtained for a certain pitch angle αₚ of the turbine blade 111 relatively the wind direction, which can be derived if the aerodynamic properties of the turbine blade, the wind direction, the wind speed, the rotation speed of the turbine blades 111 and certain properties regarding the construction, such as the diameter and the number of turbine blades 111 of the wind turbine 110 are known. Prior art pitch control arrangements for wind turbines 110, as the alternative design described above, provide a descent improvement of the efficiency of the wind turbine 110, although not fully optimizing the pitch angle variation for different flow conditions. For example it is desirable to have a pitch angle variation according to FIG. 3 for low to intermediate rotation speeds, but a pitch angle variation according to FIG. 4 at high rotations speeds. In FIG. 3 the pitch angle of the turbine blade has opposite signs on the downstream side and the upstream side respectively, whereas the turbine blade in FIG. 4 is tangentially oriented all the time. The wind, V_{w}, is indicated by an arrow.

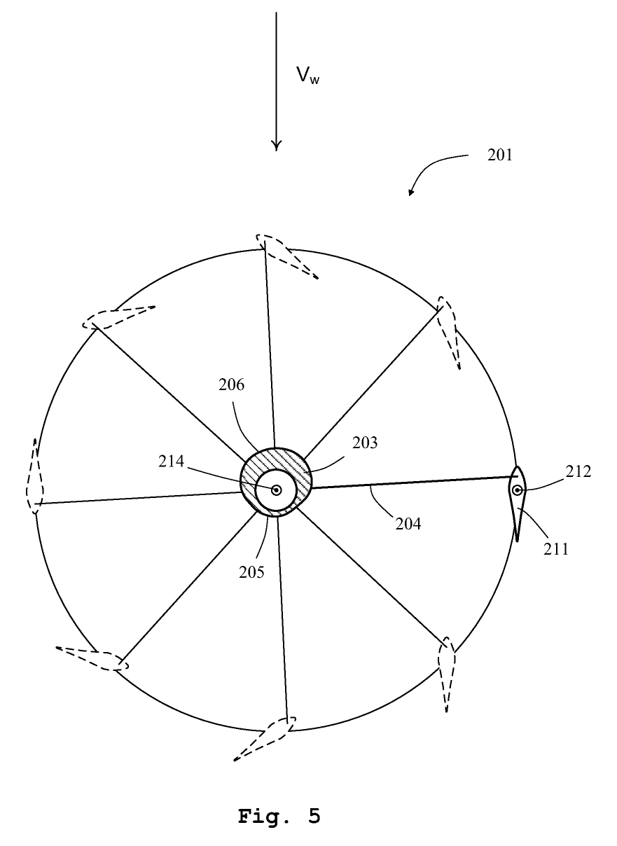

Referring to FIG. 5, one embodiment of the present invention is a pitch control arrangement 201 for a wind turbine 210 of the vertical axis type. As illustrated the wind turbine can be of the vertical axis type, however not limited to this. The wind turbine 210 comprises a turbine blade 211 arranged for rotation about a longitudinal rotation axis 214 of the wind turbine 210. The turbine blade is preferably pivoted about a longitudinal pitch axis 212 of the turbine blade 211. The pitch control arrangement 201 comprises a cam means 203 and a cam follower means 204 arranged to set the pitch angle αₚ of the turbine blade 211 in accordance with a predetermined cyclic variation as the turbine blade 211 rotates about the longitudinal rotation axis 214. Furthermore, the cam means 203 comprises a cam surface 205 of different cam profiles 206 that define different predetermined cyclic variation of the pitch angle αₚ of the turbine blade 211, in the direction of the longitudinal rotation axis 214. By way of example, FIG. 5 schematically illustrates a cross sectional view of one of the cam profiles, which is asymmetric to provide accurate pitch angle of the turbine blade in any angular position. The wind, V_{w}, is indicated by an arrow. The relative position of interaction between the cam means 203 and the cam follower means 204 in the direction of the longitudinal rotation axis 214 is variable. Hence a suitable cam profile 206 can be used to obtain a suitable pitch angle variation at a current air flow condition experienced by the turbine blade 211. This current airflow is determined by the wind speed, wind direction and the rotational speed of the turbine blade 211 about the longitudinal rotation axis 214. The relationship between the wind speed and the rotational speed is essentially comparable to the tip speed ratio in horizontal wind turbines. In addition the cam profile 206 may be designed to compensate for the downstream reduction.

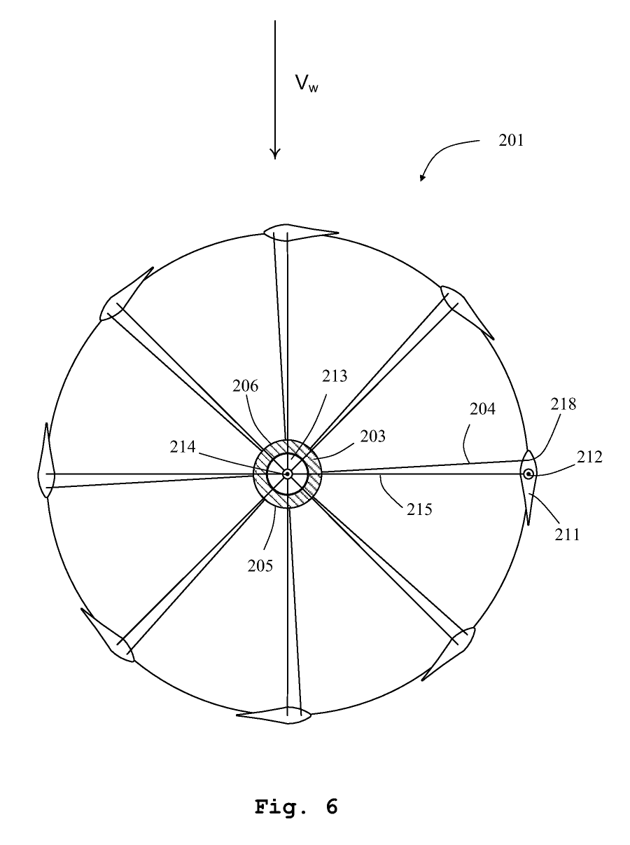

FIG. 6 illustrates one embodiment of a pitch control arrangement 201 according to the present invention for a wind turbine 210 of the vertical axis type. The wind turbine 210 comprises a turbine blade 211 pivotally arranged on a support arm 215, which is mounted on a drive shaft 213 being coaxial with the longitudinal rotation axis 214 of the wind turbine 210. The turbine blade 211 is arranged for rotation about the longitudinal rotation axis 214 of pitch control arrangement 201 and pivoted at a pivot point 218 about a longitudinal pitch axis 212 of the turbine blade 211. In one embodiment the pitch axis coincides with the aerodynamical centre of the turbine blade. The pitch control arrangement 201 further comprises a cam means 203 and a cam follower means 204 arranged to set the pitch angle of the turbine blade 211 in accordance with a predetermined cyclic variation as the turbine blade 211 rotates about the longitudinal rotation axis 214. Furthermore, the cam means 203 comprises a cam surface 205 of different cam profiles 206, which define different predetermined cyclic variation of the pitch angle of the turbine blade 211, in the direction of the longitudinal rotation axis 214. By way of example, FIG. 6 schematically illustrates a cross sectional view of one of the cam profiles, which is symmetric.

The different cam profiles 206 illustrated in FIG. 5 and FIG. 6 give different pitch angle variations. The asymmetric cam profile 206 illustrated in FIG. 5 may give a suitable cyclic pitch angle variation at relatively low wind speed. A cam profile having such properties is in this application referred to as a low-speed profile. On the other hand, the symmetric cam profile 206 illustrated in FIG. 6 may give a suitable cyclic pitch angle variation at high wind speed. A cam profile having such properties is in this application referred to as a high-speed profile. At high rotational speed the wind current due to the rotation is dominating and hence the turbine blades 211 preferably are oriented essentially in the tangential direction. Preferably the cam means 203 comprises an intermediate-speed profile which is adapted to give a suitable cyclic pitch angle variation at intermediate wind speed.

By having a plurality of different cam profiles 206 the pitch angle control arrangement 201 of the present invention adjusts the cyclic variation of the pitch angle to establish a highly efficient wind turbine 210 in a plurality of air flow conditions. In general the shape of the cam profile 206 is depending on the relationship between the wind speed and the rotation speed as well as the magnitude of the wind speed and the rotation speed, i.e. different attack angles αₐₜ and wind component V_{d}. Hence the cam profiles 206 are adapted for different wind speed vs. rotation speed relationships as well.

In one embodiment of a pitch control arrangement 201 according to the present invention the cam means 203 comprises a self-start profile. By such a cam profile 206 the cyclic variation of the pitch angle of the turbine blade 211 is e.g. controlled so that the drag force acting on the turbine blade 211 is maximized in the downstream sector 230 and minimized in the upstream sector 231. Consequently the turbine blade 211 is turned to expose a large area to the wind, i.e. the flat side, in the downstream sector 230 and substantially tangential in the upstream sector 231. This cam profile 206 is typically used for initiating rotation of the turbine blade 211 and at low rotational speed. When the turbine blades reach a certain higher rotational speed the relative position of interaction between the cam means 203 and the cam follower means 204 may be changed to another cam profile 206 to obtain a pitch angle variation that benefit from the potential lift force in any angular position of the turbine blade 211. By using the self-start profile of this embodiment the predetermined cyclic variation of the pitch angle augments a drag force acting on the turbine blade in one sector of the rotation cycle and diminishes the drag force in another sector to initiate and maintain a rotary motion of the turbine blade at low rotational speeds. In one embodiment of this kind the cam means 203 comprises a cam profile 204 that provides a cyclic pitch angle variation adapted to orient a flat side of the turbine blade 211 against the wind in the downstream sector 230 and orient a leading edge of the turbine blade 211 substantially against the wind in the upstream sector 231.

In one embodiment of a pitch control arrangement 201 according to the present invention the cam means 203 comprises a cam profile 206 suitable for power limitation. A generator of a wind turbine 210 usually has an efficiency that is highly peaked at a certain rotational speed of the drive shaft 213. Moreover the generated power rapidly increases as the rotational speed increases. Commonly wind turbines 210 are dimensioned for a maximal wind speed, which may be less than the actual maximal wind speeds the wind turbine 210 will be exposed to. Consequently the generator system may not be able to handle the high power at overspeed and in addition there is a risk for a fatal breakdown of the wind turbine construction due to the high forces exerted on the wind turbine construction. The cam profile 206 of this embodiment adjusts the pitch angle so that the driving force no longer is optimised for obtaining as high output power as possible, but limiting the rotational speed to give maximal power output and/or limiting the rotational speed to avoid overload and/or to limit the forces exerted on the wind turbine construction.

As appreciated from above a set of different cam profiles 206 can be provided along the direction of the longitudinal rotation axis 214 to provide a corresponding set of predetermined cyclic variations of the pitch angle. By way of example this can be interpreted as a set of discs arranged along the longitudinal rotation axis 214. In principle the number of different cam profiles, i.e. the number of discs, can be infinite, but in practice the number of different cam profiles 206 is limited.

According to one embodiment of the present invention the cam means provides intermediate cam profiles that define additional predetermined cyclic variations of the pitch angle. As explained in the following the intermediate cam profiles can be provided by splitting the cam means 203 into a first and a second half, whereby the predetermined cyclic variation of the pitch angle is defined by a profile on each of the halves. Moreover, the intermediated cam profiles can be provided by arranging the cam follower means 204 on a continuous transition region between different cam profiles 206.

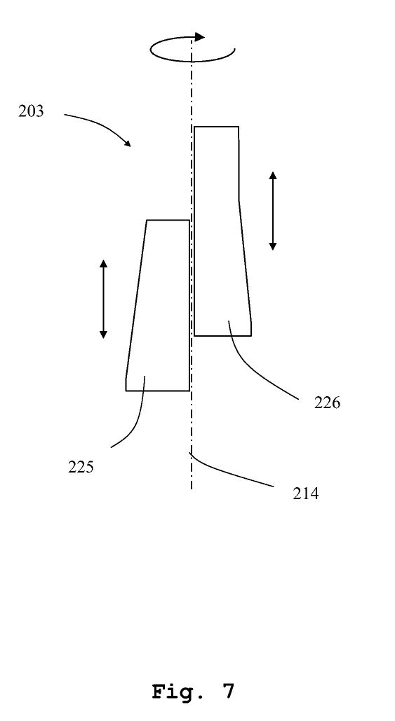

Referring to FIG. 7, in one embodiment of a pitch control arrangement 201 according to the present invention the cam means 203 comprises a cam means 203 which is split into a first and a second half 225, 226 making it suitable for compensation of the downstream reduction. The first and the second half 225, 226 are independently movable relative each other in the direction of the longitudinal rotation axis 214. Hence the cam profile 206 can be varied not only by varying the relative position of interaction between the cam means 203 and the cam follower means 204 in the direction of the longitudinal rotation axis 214, but also by changing the relative position of the first and the second half 225, 226. Thus the first half 225 can be used for pitch angle control in the upwind sector 231 and the second half 226 can be used for pitch angle control in the downwind sector 230. The downstream reduction may be accomplished by the second half 226 independently of the pitch angle variation set by the first half. Preferably, the cam means 203 is pivoted about the longitudinal rotation axis 214 for adjustment of the angular position of the cam means 203 about the longitudinal rotation axis 214.

In one embodiment of a pitch control arrangement 201 according to the present invention the cam means 203 comprises a stalling profile 206 which generates a 90° pitch angle, i.e. with the flat side of the turbine blade 211 against the wind, Vᵣ, originating from the rotation of the turbine blade 211 about the longitudinal rotation axis 214.

In one embodiment of a pitch control arrangement 201 according to the present invention the cam means 203 comprises a soft feathering profile, which decouples the pitch angle control of the turbine blade 211. In this state, a wind turbine does not generate any power. This is by way of example accomplished by moving the cam means 203 along the longitudinal direction of the rotation axis 214 to a position where the cam follower means 204 no longer are in contact with the cam means 203.

In one embodiment of a pitch control arrangement 201 according to the present invention the cam means 203 comprises an actively controlled feathering profile, which controls the pitch angle of the turbine blade 211 so that the turbine blades 211 are essentially in parallel with the wind, V_{w}, having the leading edge against the wind all the time. The wind turbine is not rotating during the actively controlled feathering.

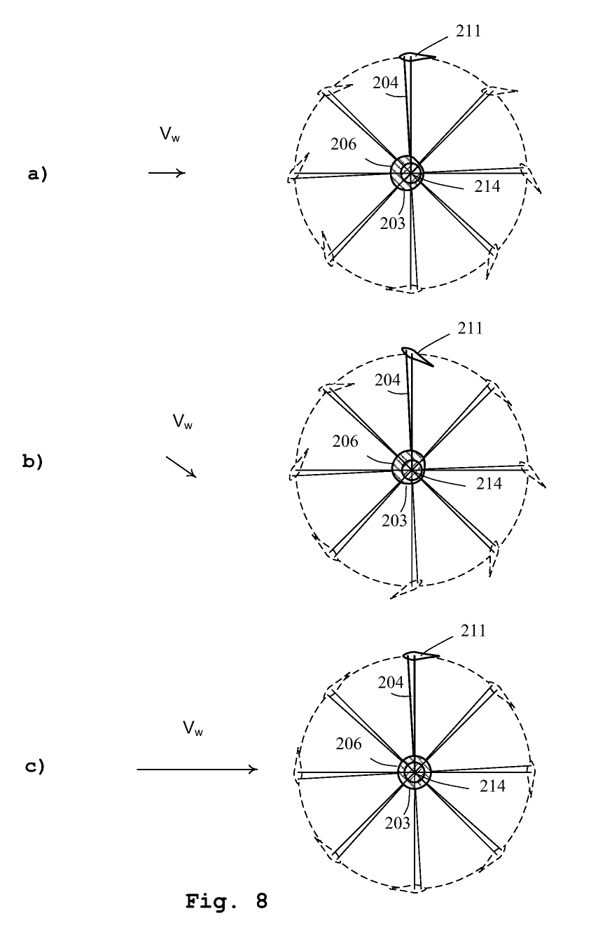

FIG. 8a-c schematically illustrate one embodiment of the pitch control arrangement 201 according to the present invention, wherein the cam means 206 are pivotally arranged about the longitudinal rotational axis 214. This can be used to adjust the pitch angle variation of the turbine blade 211 for different wind directions. FIG. 8a schematically illustrates a cam follower means 204 of a pitch control arrangement 201 positioned on an asymmetric cam profile 206 of a cam means 203 for an accurate cyclic pitch angle variation for the current low wind speed directed according to the arrow in FIG. 8a. FIG. 8b illustrates an adjustment of the cyclic pitch angle variation due to a different wind direction, although with the same wind speed, by adjustment of the angular position of the pivoted cam means 203 about the longitudinal rotation axis 214. FIG. 8c illustrates yet another adjustment of the cyclic pitch angle variation due to a higher wind speed. The position of the cam follower means 204 have been adjusted to follow a substantially symmetric cam profile 206, which benefit from the increased potential lift force.

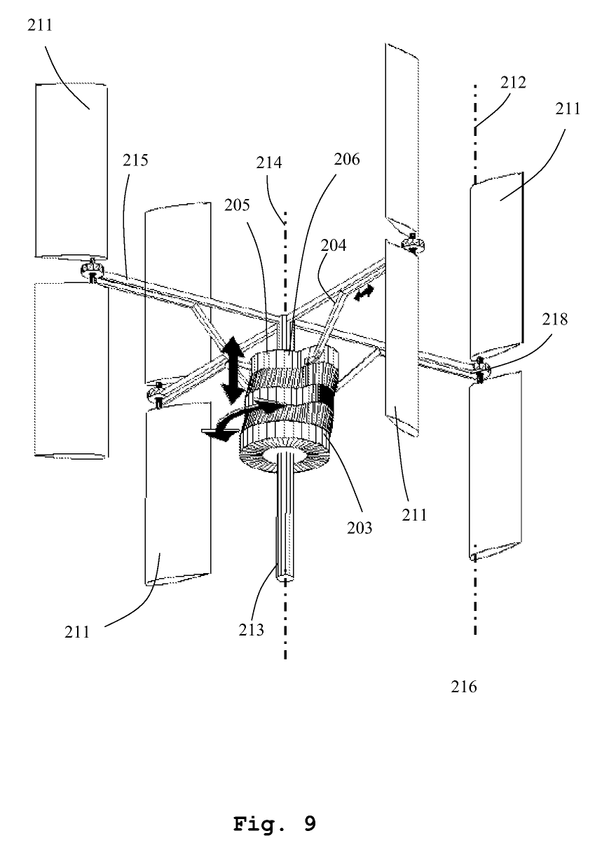

Hitherto the pitch control arrangement 201 has been described as being adapted for a single turbine blade 211. The present invention is not limited to a one-bladed design of the wind turbine 210. FIG. 9 illustrates a perspective view of a vertical axis wind turbine 210 comprising four turbine blades 211. The turbine blades 211 are pivotally arranged on a support arm 215 for rotation about a longitudinal pitch axis 212. Preferably, the pitch axis coincides with the aerodynamical centre of the turbine blade. The support arm 215 is mounted on the drive shaft 213, which is coaxial with the longitudinal rotation axis 214 of the wind turbine 210. One embodiment of a pitch control arrangement 201 for this wind turbine 210 comprises a cam means 203 and a cam follower means 204 arranged to set the pitch angles of the turbine blades 211 in accordance with a predetermined cyclic variation as the turbine blades 211 rotate about the longitudinal rotation axis 214. Furthermore, the cam means 203 comprises a cam surface 205 of different cam profiles 206, which define different predetermined cyclic variation of the pitch angle of the turbine blades 211 in the direction of the longitudinal rotation axis 214. By way of example, the cam follower means 204 comprises push rods, each pivotally arranged on a turbine blade at a pivot point 218 at the side of the longitudinal pitch axis 212, e.g. between the leading edge 216 and the longitudinal pitch axis 212. The other end of the push rod 204 follows a cam profile 206 of the cam means 203. In this embodiment the push rods are fixed vertically, i.e. relative the support arms 215 and the drive shaft 213. The cam means 203 can be displaced in the direction of the longitudinal rotation axis 214 to switch the relative position of interaction between the cam means 203 and the cam follower means 204, and thereby altering between different cam profiles 206. Moreover, the cam means 206 can be pivoted about the longitudinal rotation axis 214 to adjust the cyclic pitch angle variation for different wind directions. It should be understood that the relative position of interaction between the cam means 203 and the cam follower means 204 in the direction of the longitudinal rotation axis 214 can be obtained also by having either the cam means 203 fixed and the push rods 204 vertically movable or both the cam means 203 and the push rods 204 vertically movable.

A retaining force in the direction of the longitudinal rotation axis on the cam follower means 204, e.g. the push rods according to the embodiment above, is necessary if the cam follower means 204 is loosely arranged on the cam surface 205. The retaining force can be generated e.g. by spring means or a weight applied on the other side of the longitudinal pitch axis 212 with respect to the pivot point 218. In the latter case the weight generates a centrifugal force acting radially outward on e.g. the trailing portion and hence a force acting radially inward on the push rod. Instead of having a weight, or as a complement, the longitudinal pitch axis 212 may be placed ahead or behind the aerodynamical centre of the turbine blade 211.

According to one embodiment of the present invention at least a part of the cam surface 205 is continuously variable in the direction of the longitudinal rotation axis 214. In one embodiment this part is provided between different cam profiles to provide a continuous transition region 209 of the cam surface. Thereby the predetermined cyclic variation of the pitch angle can be varied by arranging the cam follower means 204 on such continuous transition regions 209, i.e. using the intermediate cam profiles.

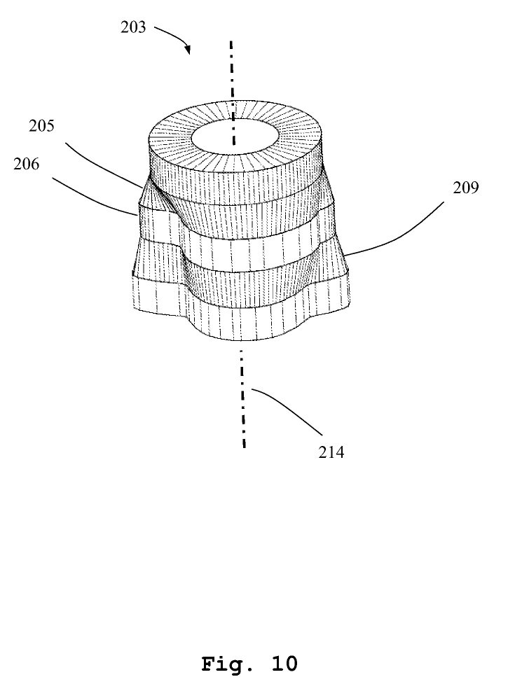

FIG. 10 schematically illustrates a cam means 203 of a pitch control arrangement 201 according to one embodiment of the present invention. The cam means 203 comprises a cam surface 205 of different cam profiles 206 in the direction of the longitudinal rotation axis 214. Each different cam profile 206 defines different predetermined cyclic variation of the pitch angle. In one embodiment of the present invention the cam means 206 can be described as an asymmetrical cylinder adapted to be arranged about the drive shaft 213, i.e. the longitudinal rotation axis 214, of a wind turbine 210. The surface 205 of the asymmetric cylinder 203 comprises a plurality of cam profiles 206 arranged in sequence in the direction of the longitudinal rotation axis 214. The cam means 203 is adapted to be pivoted about the longitudinal rotation axis 214 for adaptation to different flow directions and to be movable relatively the turbine blades in the direction of the longitudinal rotation axis 214 for adaptation to different flow conditions.

FIG. 10 illustrates a number of discrete cam profiles although in principle the number of cam profiles 206 is not limited. The cam surface 205 can have a continuously varying longitudinal profile. In one embodiment of the pitch control arrangement of the present invention the cam means comprises continuous transition regions 209 between the cam profiles 206. Thereby the altering between the cam profiles can be made smoothly and moreover, the actual cam profile 206 experienced by the cam follower means 204 can be tuned by using a relative position of interaction between the cam means 203 and the cam follower means 204 on the transition regions 209.

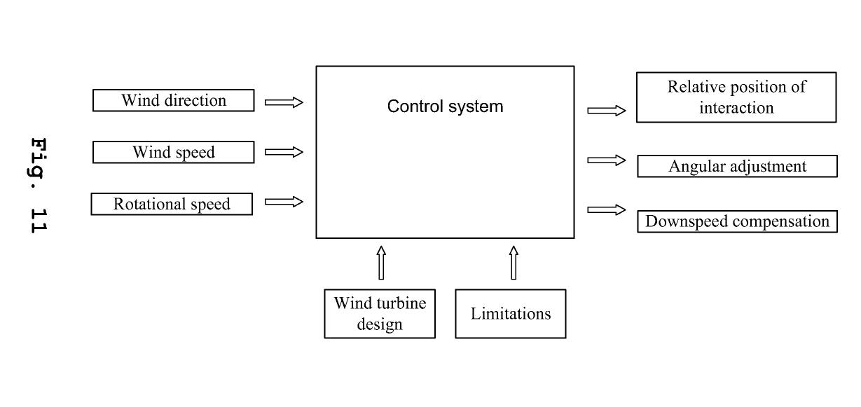

Referring to FIG. 11, in one embodiment of the present invention the pitch control arrangement 201 comprises a control system. Preferably, the control system acquires information concerning the current flow conditions, such as wind speed, wind direction and rotation speed. The control system is adapted to store information about properties, i.e. the design, of the actual wind turbine 210 and the constituting parts, such as the profiles of the turbine blade 211, the length of the support arms 215, the properties of the generator, etc. Moreover any limitations for the wind turbine may be an input to the control system. One example of such is a maximal rotation speed, which should not be exceeded as explained above. Another example is a wind speed limit at which the pitch angle of the turbine blades should be changed to at least avoid a further increase of the rotational speed. The relative position of interaction between the cam means 203 and the cam follower means 204 and the angular position of the cam means 203 about the longitudinal rotation axis 214 can be derived by the control system or a system connected to the control system at any time. The relative position of interaction as well as the angular position about the longitudinal rotational axis may be controlled by e.g. an actuator moving the cam means 203. For the embodiment wherein the cam means 203 is split into a first and a second half 225, 226, relative position of the halves 225, 226 are controlled by moving the halves 225, 226 relative each other. This can be used for the above mentioned compensation for downwind reduction. The angular adjustment of the cam means 203 due to changes in wind direction may be accomplished by passive means.

One embodiment of the present invention is a vertical axis wind turbine 210 comprising a pitch angle control arrangement 201 according to the invention. The wind turbine 210 comprises at least a first turbine blades 111, preferably having a cross sectional shape of an airfoil, arranged in a carousel manner about a longitudinal rotation axis 214.

One embodiment of the wind turbine 210 of the present invention comprises at least a plurality of turbine blades 211 having a cross sectional shape of an airfoil arranged in a carousel manner about a vertical drive shaft 213 by horizontal support arms 215. The vertical drive shaft 213 is upstanding from and rotatably mounted on a support structure 220 comprising a generator and/or a gear box at the ground level. The pitch angle of the turbine blades 211 is controlled by a pitch control arrangement 201 according to the present invention. The pitch control arrangement is operated by a control system of the wind turbine 210.

In one embodiment of the present invention the drive shaft and the longitudinal rotation axis thereof is adapted to be horizontally arranged. Consequently the turbine blades 211 are horizontally arranged as well.

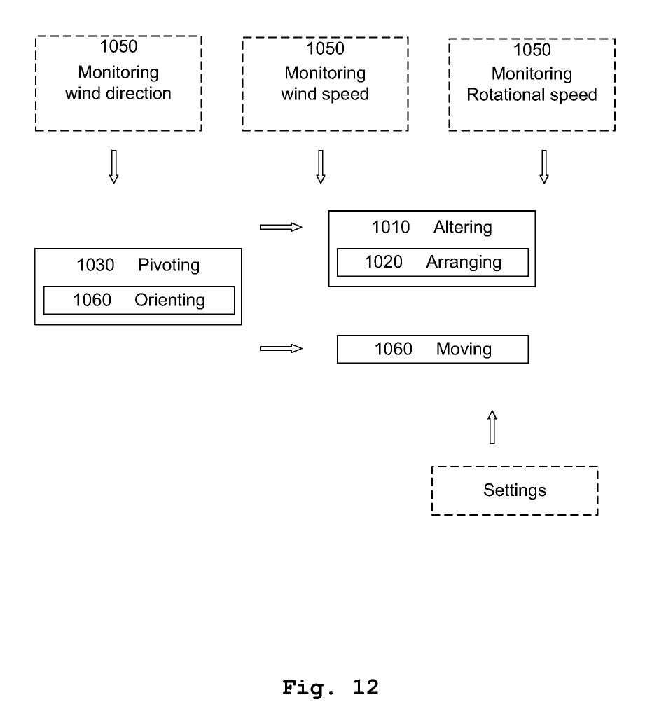

Referring to FIG. 12, the present invention provides a method for controlling a pitch angle of a turbine blade 211 in a wind turbine of the vertical axis type. The wind turbine comprises a turbine blade 211 arranged for rotation about a longitudinal rotation axis 214 of the wind turbine 210 and pivoted about a longitudinal pitch axis 212 of the turbine blade 211. The pitch control arrangement comprises a cam means 203 and cam follower means 204 arranged to set the pitch angle of the turbine blade 211 in accordance with a predetermined cyclic variation as the turbine blade 211 rotates about the longitudinal rotation axis 214.

The method comprises the step of 1010 altering a relative position of interaction between the cam means 203 and the cam follower means 204 along a longitudinal rotation axis 214 to obtain different cam profiles 206, which defines different predetermined cyclic variation of the pitch angle. The pitch angle may be controlled to give e.g. efficient power generation in a wind turbine. The predetermined pitch angle variation is typically changed due to changes in wind speed, wind direction and/or rotational speed of the turbine blades 211.

One embodiment of the method according to the present invention comprises the step of 1040 pivoting the cam means 203 to adjust the angular position of the cam means about the longitudinal rotational axis for different wind directions. The pivoting may be passive or controlled by a control system.

One embodiment of a method according to the present invention the step of altering further comprises the step of 1020 arranging the cam follower means 204 on a continuous transition region 209 between cam profiles 206. This can be used in order to smoothly switch between the cam profiles 206 or in order to provide intermediate cam profiles that are different from the cam profiles 206.

In one embodiment of the method according to the present invention the method comprises the step of 1030 moving a first and a second half 225, 226 of the cam means 203 relatively each other along the longitudinal rotation axis 214 to obtain different cam profiles 206, the cam profiles 206 defining different predetermined cyclic variation of the pitch angle.

The step of moving the first and the second half may comprise the step of 1060 orienting the cam means 203 in an angular position about the longitudinal rotational axis so that the first and second half 225, 226 determines the predetermined pitch angle variation in a upwind sector 231 and a downwind sector, respectively. Thereby the aforementioned downwind compensation is accomplished.

One embodiment of a method of the present invention comprises the step of 1050 monitoring at least the wind speed. Based on this monitoring the relative position of interaction between the cam means 203 and the cam follower means 204 may be altered to obtain a pitch angle variation that gives e.g. the highest efficiency. Furthermore the rotation speed of the turbine blade about the longitudinal rotation axis 214 may be monitored as well. Thereby the input for a decision about which cam profile to use is improved. The wind direction may be monitored and adjusted on the basis of this monitoring as well although the adjustment of the angular position of the cam means relative the wind direction can be made passively.

One embodiment of a method of the present invention comprises the step of processing input regarding wind speed, wind direction and/or rotation speed of the turbine blades 211 about the longitudinal rotation axis 214 in a control system. The control system then adjusts the pitch control arrangement 201 to obtain an advantageous pitch angle variation according to instructions or settings implemented in the control system. The instruction may for example comprise information about particular speed (wind, rotation) limits to obtain highest power output or due to safety issues.

The cam follower means 204 have been exemplified by push rods acting on a pivot point 218 on the turbine blades 211, which gives a simple mechanical construction. However, the present invention is not limited to this. The cam follower means may for example comprise hydraulic means, spring biased means, linkage systems, etc.

Although all embodiments have been described in terms of a vertical axis wind turbine, it is to be understood that the drive shaft of the wind turbine may be oriented horizontally, perpendicular to the wind direction as well. Furthermore, the present invention may be operated using other fluids than air.

The turbine blades 211 of the vertical axis wind turbines 210 described above generally are straight and have a homogenous cross sectional shape, however not limited to this. The wind turbine 210 can e.g. be of Darrieus type or others.

While the invention has been described in connection with what is presently considered to be the most practical and preferred embodiments, it is to be understood that the invention is not to be limited to the disclosed embodiments, on the contrary, is intended to cover various modifications and equivalent arrangements within the appended claims.

1-15. (canceled)

16. A pitch control arrangement for a wind turbine of the vertical axis type that comprises at least one turbine blade arranged for rotation about a longitudinal rotation axis of the wind turbine, wherein:
the pitch control arrangement comprises cam means and cam follower means arranged to set the pitch angle of the turbine blade in accordance with a predetermined cyclic variation as the turbine blade rotates about the longitudinal rotation axis;
the cam means comprises a cam surface of different cam profiles in the direction of the longitudinal rotation axis, wherein the different cam profiles define different predetermined cyclic variation of the pitch angle; and
the relative position of interaction between the cam means and the cam follower means in the direction of the longitudinal rotation axis is variable.

17. The pitch control arrangement according to claim 16, wherein the cam means provides intermediate cam profiles that define additional predetermined cyclic variations of the pitch angle.

18. The pitch control arrangement according to claim 16, wherein the cam surface is continuously variable in the direction of the longitudinal rotation axis.

19. The pitch control arrangement according to claim 16, wherein the cam surface comprises a continuous transition region between different cam profiles.

20. The pitch control arrangement according to claim 19, wherein the predetermined cyclic variation of the pitch angle can be varied by arranging the cam follower means on the continuous transition regions.

21. The pitch control arrangement according to claim 16, wherein the cam means is split into a first half and a second half that are movable relatively each other in the direction of the longitudinal rotational axis.

22. The pitch control arrangement according to claim 21, wherein the predetermined cyclic variation of the pitch angle can be varied by moving the first half and the second half relatively each other.

23. The pitch control arrangement according to claim 21, wherein the first half is adapted to control the pitch angle in an upwind sector and the second half is adapted to control the pitch angle in a downwind sector.

24. The pitch control arrangement according to claim 16, wherein the cam means is pivoted about the longitudinal rotation axis for adjustment of an angular position of the cam means about the longitudinal rotation axis.

25. The pitch control arrangement according to claim 16, wherein the cam means comprises cam profiles for different wind speed regimes and/or rotation speed regimes.

26. The pitch control arrangement according to claim 16, wherein the cam means is movable along the longitudinal rotation axis, and the cam follower means is fixed in the longitudinal direction.

27. A wind turbine of the vertical axis type comprising a pitch control arrangement with at least one turbine blade arranged for rotation about a longitudinal rotation axis of the wind turbine, wherein:
the pitch control arrangement comprises cam means and cam follower means arranged to set the pitch angle of the turbine blade in accordance with a predetermined cyclic variation as the turbine blade rotates about the longitudinal rotation axis;
the cam means comprises a cam surface of different cam profiles in the direction of the longitudinal rotation axis, wherein the different cam profiles define different predetermined cyclic variation of the pitch angle; and
the relative position of interaction between the cam means and the cam follower means in the direction of the longitudinal rotation axis is variable.

28. The wind turbine according to claim 27, wherein the cam surface comprises a continuous transition region between different cam profiles.

29. The wind turbine according to claim 28, wherein the predetermined cyclic variation of the pitch angle can be varied by arranging the cam follower means on the continuous transition regions.

30. The wind turbine according to claim 27, wherein the cam means is split into a first half and a second half that are movable relatively each other in the direction of the longitudinal rotational axis.

31. A method for controlling a pitch control arrangement with at least one turbine blade arranged for rotation about a longitudinal rotation axis of the wind turbine, wherein:
the pitch control arrangement comprises cam means and cam follower means arranged to set the pitch angle of the turbine blade in accordance with a predetermined cyclic variation as the turbine blade rotates about the longitudinal rotation axis;
the cam means comprises a cam surface of different cam profiles in the direction of the longitudinal rotation axis, wherein the different cam profiles define different predetermined cyclic variation of the pitch angle; and
the relative position of interaction between the cam means and the cam follower means in the direction of the longitudinal rotation axis is variable, the method characterized by the step of altering a relative position of interaction between the cam means and the cam follower means along a longitudinal rotation axis to obtain different predetermined cyclic variation of the pitch angle.

32. The method for controlling the pitch angle according to claim 31, further comprising the step of arranging the cam follower means on a continuous transition region between cam profiles.

33. The method for controlling the pitch angle according to claim 31, further comprising the step of moving a first and a second half of the cam means relatively each other along the longitudinal rotation axis to obtain different cam profiles that define different predetermined cyclic variation of the pitch angle.
